(19) United States
(12) Patent Application Publication
(10) Pub. No.: US 2026/0031715 A1
(43) Pub. Date: Jan. 29, 2026

(54) POWER SOURCE CIRCUIT WITH MULTIFUNCTIONAL PINS AND CONTROL METHOD THEREOF

(71) Applicant: Richtek Technology Corporation, Zhubei City (TW)

(72) Inventors: Kun-Yu Lin, Hsinchu (TW); Shin-Li Lin, Hsinchu (TW)

(21) Appl. No.: 19/260,367

(22) Filed: Jul. 4, 2025

Related U.S. Application Data
(60) Provisional application No. 63/676,902, filed on Jul. 29, 2024.

(30) Foreign Application Priority Data
Feb. 14, 2025 (TW) 114105516

(51) Int. Cl. H02M 1/32; G01K 7/16; H02M 1/00

(52) U.S. Cl. CPC H02M 1/327; G01K 7/16; H02M 1/0009

(57) ABSTRACT

A power source circuit includes: a first and a second multifunctional pins, configured for communication and temperature sensing. A temperature sensing component is coupled between the first and second multifunctional pins. In a connection detection mode, a connection detection current is provided through the first and/or second multifunctional pin to detect whether a power sink circuit is connected to the power source circuit. The power sink circuit includes a pull-down resistor couple to the first and/or second multifunctional pin for determining whether the power source circuit is connected to the power sink circuit. When the power sink circuit is connected to the power source circuit, in a temperature sensing mode, the first and second multifunctional pins are configured into a temperature sensing configuration to generate an electrical characteristic on the temperature sensing component, and to obtain the electrical characteristic through the first and/or second multifunctional pin, thereby performing temperature sensing.

### CROSS REFERENCE

The present invention claims priority to the provisional application Ser. No. 63/676,902, filed on Jul. 29, 2024 and claims priority to the TW patent application No. 114105516, filed on Feb. 14, 2025.

### BACKGROUND OF THE INVENTION

### Field of Invention

The present invention relates to a conversion control circuit. Particularly it relates to a conversion control circuit for controlling a resonant power converter. The present invention also relates to a control method for controlling the above resonant power converter.

### Description of Related Art

FIG. 1 illustrates a schematic circuit diagram of a power system of a prior art, which includes a power source circuit and a power sink circuit electrically connected to each other via a cable. In this prior art, a temperature sensing function is implemented, for example, through a dedicated pin of the power source communication and control circuit (which may be an integrated circuit), such as an independent over-temperature protection pin TS. These pins are specifically used for connecting a negative temperature coefficient (NTC) resistor or other sensing components to detect the temperature condition of the system. For example, as shown in FIG. 1, in applications of the Universal Serial Bus Type-C (USB Type-C) specification, configuration channel pins CC1_src and CC2_src of the power source circuit are primarily used to perform connection detection, orientation determination, and current capability negotiation between a source and a sink. The configuration channel pins CC1_src and CC2_src are used to detect whether configuration channel pins CC1_snk or CC2_snk of the power sink circuit are connected to the configuration channel pins CC1_src or CC2_src of the power source circuit. The temperature sensing pin TS is coupled to an external NTC resistor of the integrated circuit chip to perform an over-temperature protection operation.

The drawback of the prior art described above is that dedicated temperature sensing pins require additional hardware resources and pin count, which increases the package size and cost of the chip, and limits the design flexibility for compact electronic devices.

In view of the above, the present invention provides a power conversion and transmission system having multifunctional pins to overcome the drawbacks of the prior art.

### SUMMARY OF THE INVENTION

From one perspective, the present invention provides a power source circuit, comprising: a first multifunctional pin and a second multifunctional pin, configured for communication and temperature sensing, wherein a temperature sensing component is coupled between the first multifunctional pin and the second multifunctional pin; wherein, in a connection detection mode, a first connection detection current is provided through the first multifunctional pin and/or a second connection detection current is provided through the second multifunctional pin, to detect whether a power sink circuit is connected to the power source circuit, wherein the power sink circuit includes a pull-down resistor coupled to the first multifunctional pin and/or the second multifunctional pin for determining whether the power source circuit is connected to the power sink circuit; wherein, when the power sink circuit is connected to the power source circuit, in a temperature sensing mode, the first multifunctional pin and the second multifunctional pin are configured into a temperature sensing configuration to generate an electrical characteristic on the temperature sensing component, and to obtain the electrical characteristic through the first multifunctional pin and/or the second multifunctional pin, thereby performing temperature sensing and obtaining a temperature information.

In one embodiment, the temperature sensing configuration includes: providing a first predetermined voltage or a first predetermined current through the first multifunctional pin, or configuring the first multifunctional pin as floating; and providing a second predetermined voltage or a second predetermined current through the second multifunctional pin, or configuring the second multifunctional pin as floating; wherein the electrical characteristic includes at least one of the following: a voltage on the first multifunctional pin, a current through the first multifunctional pin, a voltage on the second multifunctional pin, a current through the second multifunctional pin, and/or a resistance value of the temperature sensing component.

In one embodiment, when the power sink t is connected to the power source circuit, one multifunctional pin of the first multifunctional pin and the second multifunctional pin is connected to the power sink circuit, and the other multifunctional pin of the first multifunctional pin and the second multifunctional pin is not connected to the power sink circuit; wherein the temperature sensing configuration includes one of the following: (1) providing a temperature sensing current through the other multifunctional pin and configuring the one multifunctional pin as floating; (2) providing a predetermined high voltage through the other multifunctional pin and configuring the one multifunctional pin as floating; or (3) providing a temperature sensing current through the one multifunctional pin and providing a predetermined low voltage through the other multifunctional pin.

In one embodiment, the power source circuit complies with a universal serial bus (USB) Type-C specification, and the first multifunctional pin and the second multifunctional pin respectively correspond to a first configuration channel (CC) pin and a second configuration channel (CC) pin of the USB Type-C.

In one embodiment, after the power sink circuit is connected to the power source circuit, in a digital communication mode, the power source circuit further performs digital communication with the power sink circuit through the first CC pin or the second CC pin, wherein the digital communication mode and the temperature sensing mode are operated in non-overlapping time domains.

In one embodiment, the first multifunctional pin and the second multifunctional pin are further configured to perform digital communication with the power sink circuit in a digital communication mode, wherein the digital communication mode and the temperature sensing mode are operated in non-overlapping time domains.

In one embodiment, the power source circuit is further configured, in the temperature sensing mode, to detect whether the first multifunctional pin or the second multifunctional pin is performing digital communication with the power sink circuit, and when such digital communication is detected, the temperature information generated in the temperature sensing mode is disregarded, and temperature sensing is performed again when the temperature sensing mode is subsequently entered.

In one embodiment, the first connection detection current and the second connection detection current are provided by a pull-up resistor or a current source circuit.

In one embodiment, in the temperature sensing mode, when the electrical characteristic exceeds a predetermined threshold indicating that the temperature information is higher than an over-temperature threshold, an over-temperature protection (OTP) operation is performed.

In one embodiment, the temperature sensing current is lower than both the first connection detection current and the second connection detection current.

In one embodiment, in the temperature sensing mode, a voltage across the temperature sensing component is obtained by measuring the voltage on the first multifunctional pin and/or measuring the voltage on the second multifunctional pin, or a current through the temperature sensing component is obtained by measuring the current through the first multifunctional pin and/or the second multifunctional pin.

In one embodiment, in the connection detection mode, whether the power sink circuit is connected to the power source circuit is determined based on the voltage on the first multifunctional pin the and voltage on the second multifunctional pin, and when the power sink circuit is detected to be connected to one of the first multifunctional pin and the second multifunctional pin, the first connection detection current or the second connection detection current of the other multifunctional pin is disabled.

In one embodiment, the temperature sensing component is configured as a negative temperature coefficient (NTC) resistor.

In one embodiment, the temperature information is obtained in one of the following ways: when the temperature sensing configuration is configured as (1) or (2), the temperature information is determined based on a voltage across the temperature sensing component and a current through the other multifunctional pin; when the temperature sensing configuration is configured as (1) or (2), the temperature information is determined based on a voltage division ratio between the temperature sensing component and the pull-down resistor; when the temperature sensing configuration is configured as (2), the temperature information is determined based on a voltage on the one multifunctional pin; or when the temperature sensing configuration is configured as (3), the temperature information is determined based on a voltage on the one multifunctional pin.

In one embodiment, the temperature information is further determined based on a resistance value of the pull-down resistor.

In one embodiment, the first connection detection current and the second connection detection current are provided by a first current source circuit and a second current source circuit, respectively, and the resistance value of the temperature sensing component is large enough such that, in the connection detection mode, when the power sink circuit is connected to one of the first multifunctional pin and the second multifunctional pin, the first current source circuit or the second current source circuit of the other multifunctional pin adaptively switches to a low impedance and is coupled to a high voltage.

From another perspective, the present invention provides a control method for controlling a power source circuit, comprising: providing a first multifunctional pin and a second multifunctional pin, configured for communication and temperature sensing, wherein a temperature sensing component is coupled between the first multifunctional pin and the second multifunctional pin; in a connection detection mode, providing a first connection detection current through the first multifunctional pin and/or providing a second connection detection current through the second multifunctional pin to detect whether a power sink circuit is connected to the power source circuit, wherein the power sink circuit includes a pull-down resistor coupled to the first multifunctional pin and/or the second multifunctional pin for determining whether the power source circuit is connected to the power sink circuit; when the power sink circuit is connected to the power source circuit, in a temperature sensing mode, configuring the first multifunctional pin and the second multifunctional pin into a temperature sensing configuration to generate an electrical characteristic on the temperature sensing component; and obtaining the electrical characteristic through the first multifunctional pin and/or the second multifunctional pin to perform temperature sensing and obtain temperature information.

The temperature sensing function is integrated into the configuration channel pins CC1 and CC2 of USB Type-C, thereby enabling multifunctional pin usage. By arranging a temperature sensing component (e.g., an NTC resistor) between the configuration channel pins CC1 and CC2 and utilizing the pins for temperature sensing during communication inactivity, the need for dedicated temperature sensing pins is eliminated. The present invention not only saves hardware resources and reduces the number of pins required in chip packaging, but also significantly improves system integration.

The objectives, technical details, features, and effects of the present invention will be better understood with regard to the detailed description of the embodiments below, with reference to the attached drawings.

### BRIEF DESCRIPTION OF THE DRAWINGS

FIG. 1 illustrates a schematic circuit diagram of a power system of a prior art.

FIG. 2 illustrates a circuit block diagram of a power source circuit and a power sink circuit according to an embodiment of the present invention.

FIGS. 3A to 3C illustrate several embodiments of the power source circuit and the power sink circuit according to the present invention.

FIG. 4A illustrates a waveform diagram corresponding to the operation of configuration (1) of the temperature sensing mode according to the present invention.

FIG. 4B illustrates a waveform diagram corresponding to configuration (2) of the temperature sensing mode according to the present invention.

FIG. 4C illustrates a waveform diagram corresponding to configuration (3) of the temperature sensing mode according to the present invention.

FIGS. 5A and 5B illustrate partial schematic diagrams of the power source circuit according to embodiments of the present invention.

FIG. 6A illustrates an operational flowchart of the power source circuit according to one embodiment of the present invention.

FIG. 6B illustrates another operational flowchart of the power source circuit according to another embodiment of the present invention.

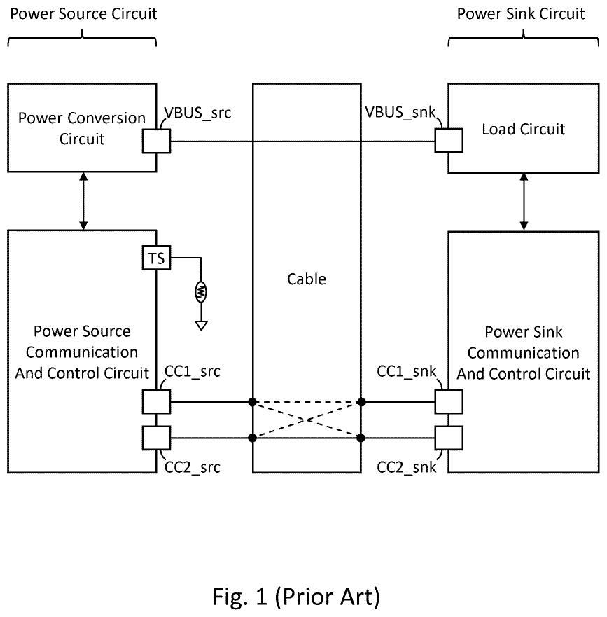

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

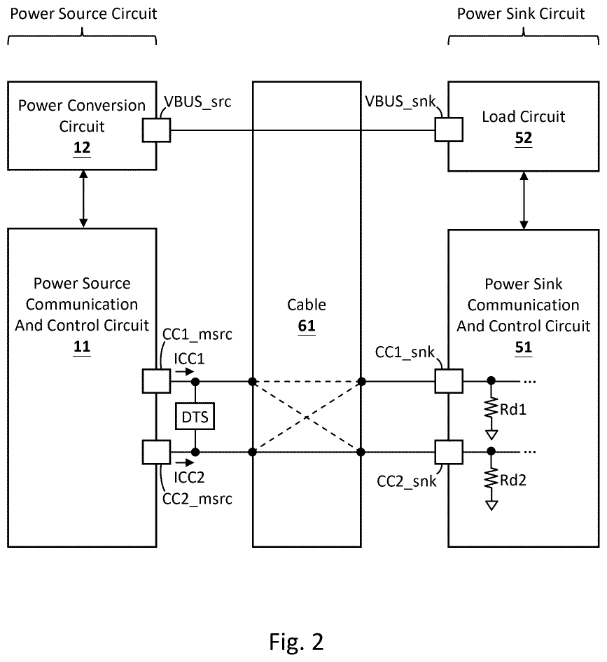

FIG. 2 illustrates a circuit block diagram of a power source circuit and a power sink circuit according to an embodiment of the present invention. As shown in FIG. 2, in one embodiment, the power source circuit includes a power source communication and control circuit 11 and a power conversion circuit 12. The power conversion circuit 12 includes a power bus pin VBUS_src, and the power source communication and control circuit 11 includes a first multifunctional pin CC1_msrc and a second multifunctional pin CC2_msrc. In one embodiment, the power source communication and control circuit 11 may be configured as an integrated circuit (IC), and the first multifunctional pin CC1_msrc and the second multifunctional pin CC2_msrc correspond to pins of the IC and may also correspond to the configuration channel (CC) pins of a USB Type-C connector. The power bus pin VBUS_src corresponds to a power pin of the USB Type-C connector.

In addition to communication, the first multifunctional pin CC1_msrc and the second multifunctional pin CC2_msrc are configured for temperature sensing, and a temperature sensing component DTS (such as a negative temperature coefficient (NTC) resistor) is coupled between the first multifunctional pin CC1_msrc and the second multifunctional pin CC2_msrc. Temperature information can be obtained through the configuration and measurement techniques described later.

In one embodiment, the temperature sensing component DTS is located external to the integrated circuit when the power source communication and control circuit 11 is implemented as an integrated circuit.

In one embodiment, in a connection detection mode, the power source circuit provides a first connection detection current ICC1 through the first multifunctional pin CC1_msrc and/or a second connection detection current ICC2 through the second multifunctional pin CC2_msrc to detect whether a power sink circuit is connected to the power source circuit. In a specific embodiment, both the first connection detection current ICC1 and the second connection detection current ICC2 are 330 μA. In one embodiment, the power sink circuit includes a power sink communication and control circuit 51 and a load circuit 52. The load circuit 52 includes a power bus pin VBUS_snk, and the power sink communication and control circuit 51 includes configuration channel pins CC1_snk and CC2_snk. In one embodiment, the power sink circuit further includes a pull-down resistor Rd1 and a pull-down resistor Rd2 for determining whether the power sink circuit is connected to the power source circuit.

It should be noted that in one embodiment, as shown by the dashed and solid lines in the cable 61 of FIG. 2, when the power sink circuit is connected to the power source circuit, the pull-down resistor Rd1 is coupled to the first multifunctional pin CC1_msrc or the second multifunctional pin CC2_msrc via the configuration channel pin CC1_snk through the cable 61, and/or the pull-down resistor Rd2 is coupled to the first multifunctional pin CC1_msrc or the second multifunctional pin CC2_msrc via the configuration channel pin CC2_snk through the cable 61. Specifically, in this embodiment, as shown by the solid line in the cable 61 of FIG. 2, the pull-down resistor Rd2 is coupled to the second multifunctional pin CC2_msrc via the configuration channel pin CC2_snk. USB Type-C supports bidirectional coupling, and therefore various combinations of connections between the power source and power sink circuits are possible and will be described in more detail later.

In one embodiment, when the power sink circuit is connected to the power source circuit, in a temperature sensing mode, the first multifunctional pin CC1_msrc and the second multifunctional pin CC2_msrc are configured into a temperature sensing configuration such that the temperature sensing component DTS generates a measurable electrical characteristic under the configuration. For example, by measuring the voltage and/or current on the first multifunctional pin CC1_msrc and/or the second multifunctional pin CC2_msrc, a resistance value RN of the temperature sensing component DTS can be obtained, and corresponding temperature information can thereby be acquired. Detailed operations will be described in the subsequent paragraphs.

In the temperature sensing mode, the present invention primarily obtains temperature information by calculating the resistance value RN of the temperature sensing component DTS (e.g., an NTC resistor). Methods for obtaining the resistance value RN include: (1) I-V calculation method: supplying a known current (I) and measuring the voltage (V), or supplying a known voltage and measuring the current, and calculating the resistance RN using R=V/I; (2) voltage/current division method: forming a voltage divider current divider with the temperature sensing component DTS and the pull-down resistor, and using the known resistance value of the pull-down resistor and the measured division ratio to indirectly calculate the resistance RN. Once the resistance value RN is obtained, the temperature can be calculated based on the characteristic curve of the NTC resistor. It should be noted that in practical implementations, under predetermined conditions, the temperature information can also be indirectly obtained by measuring the voltage or current.

In one embodiment, the power source circuit of FIG. 2 complies with the universal serial bus (USB) Type-C specification, and the first multifunctional pin CC1_msrc and the second multifunctional pin CC2_msrc respectively correspond to the first configuration channel pin CC1 and the second configuration channel pin CC2 of the USB Type-C.

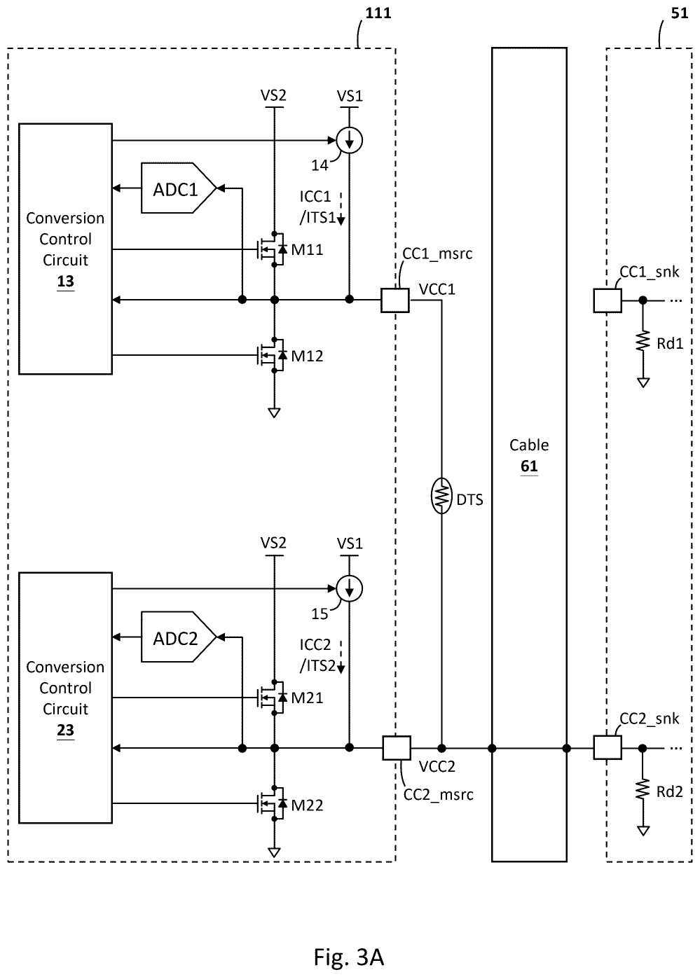

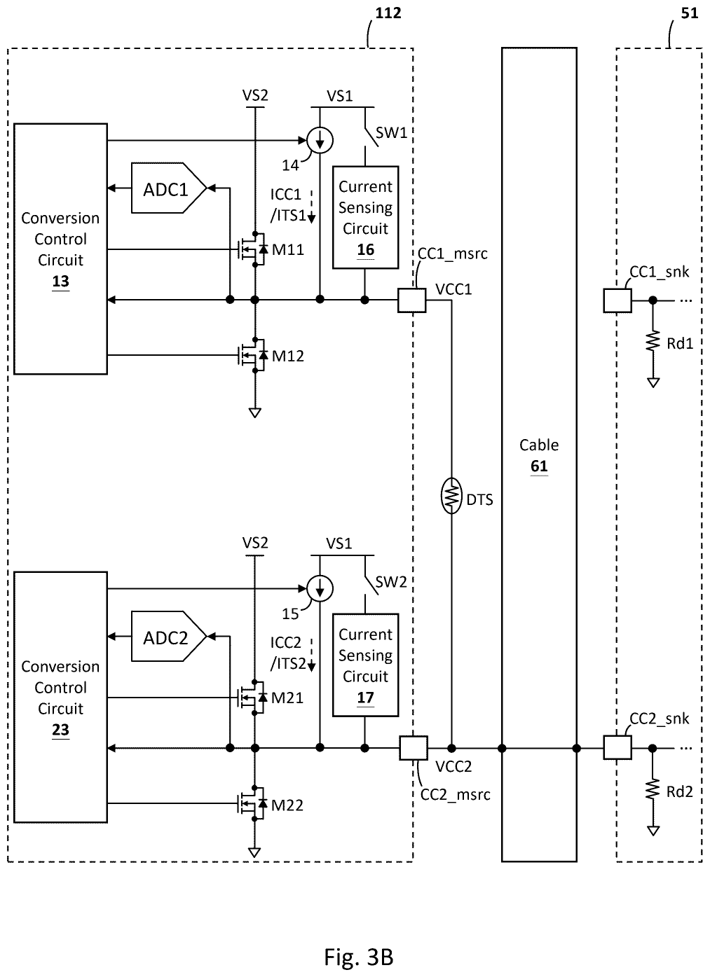

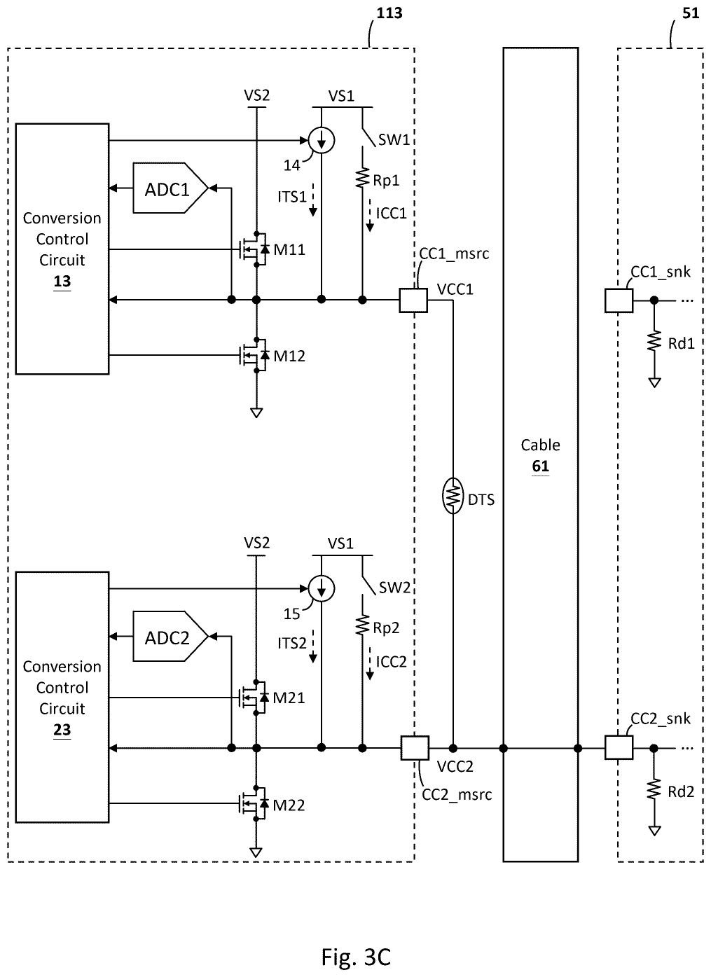

FIGS. 3A to 3C illustrate several embodiments of the power source circuit and the power sink circuit according to the present invention. In one embodiment, as shown in FIG. 3A, the power source communication and control circuit 111 includes conversion control circuits 13 and 23, analog-to-digital converters ADC1 and ADC2, transistors M11, M12, M21, and M22, and a first current source circuit 14 and a second current source circuit 15. In one embodiment, the first current source circuit 14 is coupled between a first supply voltage VS1 (e.g., 5V) and the first multifunctional pin CC1_msrc, and the second current source circuit 15 is coupled between the first supply voltage VS1 and the second multifunctional pin CC2_msrc. Transistors M11 and M12 are coupled in series between a second supply voltage VS2 (e.g., 1.125V) and ground, and transistors M21 and M22 are also coupled in series between the second supply voltage VS2 and ground. The temperature sensing component DTS is a negative temperature coefficient (NTC) resistor having the resistance value RN. In one embodiment, when the power sink circuit is connected to the power source circuit, one multifunctional pin of the first multifunctional pin CC1_msrc and the second multifunctional pin CC2_msrc is connected to the power sink circuit, and the other multifunctional pin of the first multifunctional pin CC1_msrc and the second multifunctional pin CC2_msrc is not connected to the power sink circuit. Specifically, in this embodiment, the one multifunctional pin connected to the power sink circuit corresponds to the second multifunctional pin CC2_msrc, and the other multifunctional pin not connected to the power sink circuit corresponds to the first multifunctional pin CC1_msrc.

Next, when the power sink circuit is connected to the power source circuit, the power source circuit may enter a temperature sensing mode, and the first multifunctional pin CC1_msrc and the second multifunctional pin CC2_msrc are configured into a temperature sensing configuration. In one specific embodiment, the temperature sensing configuration includes one of the following:

Configuration (1): providing a temperature sensing current ITS1 through the first multifunctional pin CC1_msrc that is not connected to the power sink circuit, and configuring the second multifunctional pin CC2_msrc that is connected to the power sink circuit as floating. That is, the temperature sensing component DTS and the pull-down resistor Rd2 are electrically connected in series to the ground potential and are biased by the temperature sensing current ITS1 through the first multifunctional pin CC1_msrc. Specifically, in one embodiment of FIG. 3A, for example, the first current source circuit 14 is controlled to generate the temperature sensing current ITS1 and to provide it through the first multifunctional pin CC1_msrc to the temperature sensing component DTS and the pull-down resistor Rd2. All switches M11, M12, M21, and M22 are turned off, and the second current source circuit 15 is disabled and does not output current, thereby configuring the power source circuit into configuration (1).

Configuration (2): providing a high voltage through the first multifunctional pin CC1_msrc that is not connected to the power sink circuit, and configuring the second multifunctional pin CC2_msrc that is connected to the power sink circuit as floating. That is, the temperature sensing component DTS and the pull-down resistor Rd2 are electrically connected in series between the high voltage and the ground potential. Specifically, in one embodiment of FIG. 3A, for example, the first current source circuit 14 is controlled to provide a temperature sensing current ITS1 that is sufficiently high and to provide it through the first multifunctional pin CC1_msrc to the temperature sensing component DTS and the pull-down resistor Rd2, or the resistance value RN of the temperature sensing component DTS is sufficiently high such that the first multifunctional pin CC1_msrc is electrically connected with low impedance to the first supply voltage VS1 (high voltage). All switches M11, M12, M21, and M22 are turned off, and the second current source circuit 15 is disabled and does not output current, thereby configuring the power source circuit into configuration (2). In another embodiment of FIG. 3A, the switch M11 is turned on to connect the first multifunctional pin CC1_msrc with low impedance to the second supply voltage VS2 (high voltage), while the other switches M12, M21, and M22 are turned off, and both the first current source circuit 14 and the second current source circuit 15 are disabled and do not output current, thereby also configuring the power source circuit into configuration (2).

Configuration (3): providing a temperature sensing current ITS2 through the second multifunctional pin CC2_msrc that is connected to the power sink circuit, and providing a low voltage (e.g., ground) through the first multifunctional pin CC1_msrc that is not connected to the power sink circuit. That is, the temperature sensing component DTS and the pull-down resistor Rd2 are electrically connected in parallel to the ground potential, and this parallel branch is biased by the temperature sensing current ITS2 from the second multifunctional pin CC2_msrc. Specifically, in one embodiment of FIG. 3A, for example, switch M12 is turned on, while switches M11, M21, and M22 are turned off, such that the second current source circuit 15 is controlled to generate the temperature sensing current ITS2 and to provide it through the second multifunctional pin CC2_msrc to the temperature sensing component DTS and the pull-down resistor Rd2, and the first current source circuit 14 is disabled and does not output current, thereby configuring the power source circuit into configuration (3).

In the above configurations, floating of the first multifunctional pin CC1_msrc or the second multifunctional pin CC2_msrc means that the pin is not electrically connected with low impedance to a voltage source or biased by a current source circuit (e.g., the first current source circuit 14 or the second current source circuit 15 is turned off or set to 0), but may still be coupled to a sensing circuit with high input impedance (such as an ADC) for voltage measurement.

In one embodiment, the temperature sensing currents ITS1 and ITS2 are lower than both the first connection detection current ICC1 and the second connection detection current ICC2. In a specific embodiment, the aforementioned high voltage is, for example, 5V, the low voltage is, for example, a ground voltage, the temperature sensing currents ITS1 and ITS2 are both 80 ρA, and both the first supply voltage VS1 and the second supply voltage VS2 are 5V. In this embodiment, as shown in FIG. 3A, in the connection detection mode, the first current source circuit 14 and the second current source circuit 15 are configured to provide the first connection detection current ICC1 and the second connection detection current ICC2, respectively. In the temperature sensing mode, the first current source circuit 14 and the second current source circuit 15 are configured to provide the temperature sensing currents ITS1 and ITS2, respectively.

In one embodiment, when the temperature sensing configuration of the first multifunctional pin CC1_msrc and the second multifunctional pin CC2_msrc is set to configuration (1), a voltage VN across the temperature sensing component DTS is determined based on the temperature sensing current ITS1 and the resistance value RN of the temperature sensing component DTS, i.e., VN=ITS1×RN. In other words, the temperature information can be calculated or retrieved from a lookup table based on the measured voltage VN. Alternatively, if the resistance value of the pull-down resistor, such as Rd2, is known, the temperature information can also be obtained by calculating or referring to the voltage division ratio or by a pre-recorded lookup table.

In another embodiment, when the temperature sensing configuration of the first multifunctional pin CC1_msrc and the second multifunctional pin CC2_msrc is set to configuration (2), the temperature sensing component DTS and the pull-down resistor Rd2 are electrically connected in series between a high voltage (e.g., 1.125V or 5V) and ground, forming a voltage divider. Accordingly, a voltage division ratio can be determined by measuring a voltage VCC2 on the second multifunctional pin CC2_msrc, and a resistance value RN and corresponding temperature information can be obtained. In one embodiment, when the pull-down resistor Rd2 and the high voltage are known and fixed, the temperature information can be directly obtained by measuring the voltage VCC2 or by referring to a lookup table.

In still another embodiment, when the temperature sensing configuration of the first multifunctional pin CC1_msrc and the second multifunctional pin CC2_msrc is set to configuration (3), the voltage VN across the temperature sensing component DTS is determined based on an equivalent resistance formed by the temperature sensing component DTS and the pull-down resistor Rd2 connected in parallel, and the temperature sensing current ITS2, thereby allowing the resistance value RN and the corresponding temperature information to be obtained by acquiring the voltage VN. In one embodiment, when the pull-down resistor Rd2 and the temperature sensing current ITS2 are known and fixed, the temperature information can be directly obtained by measuring the voltage VCC2 (i.e., VN) or by referring to a lookup table.

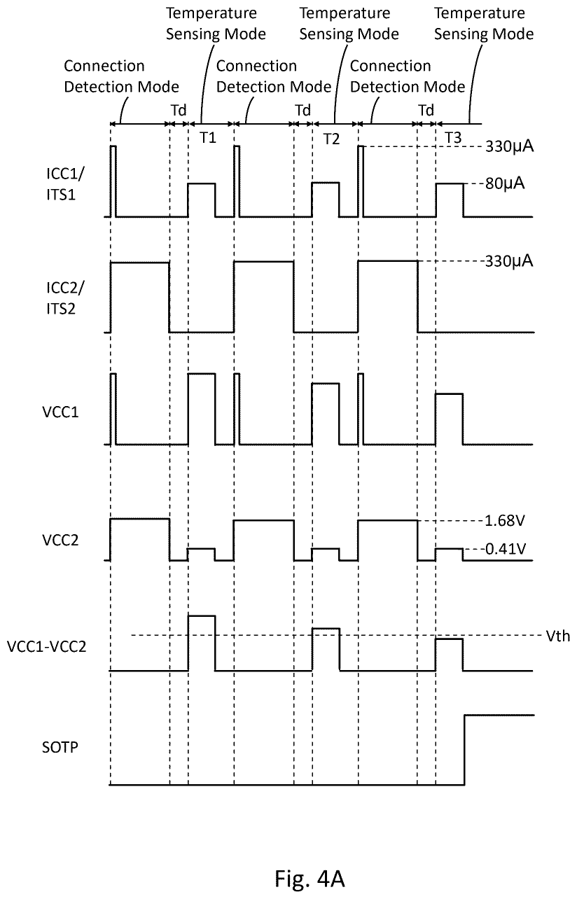

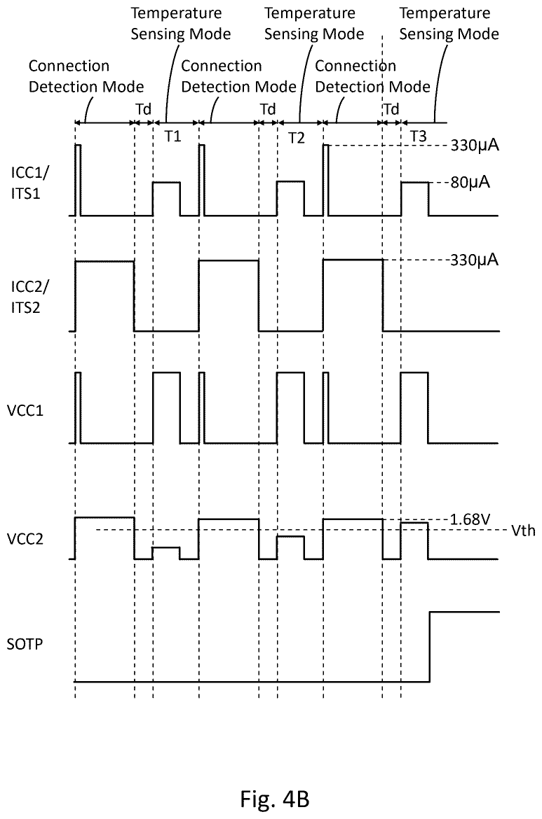

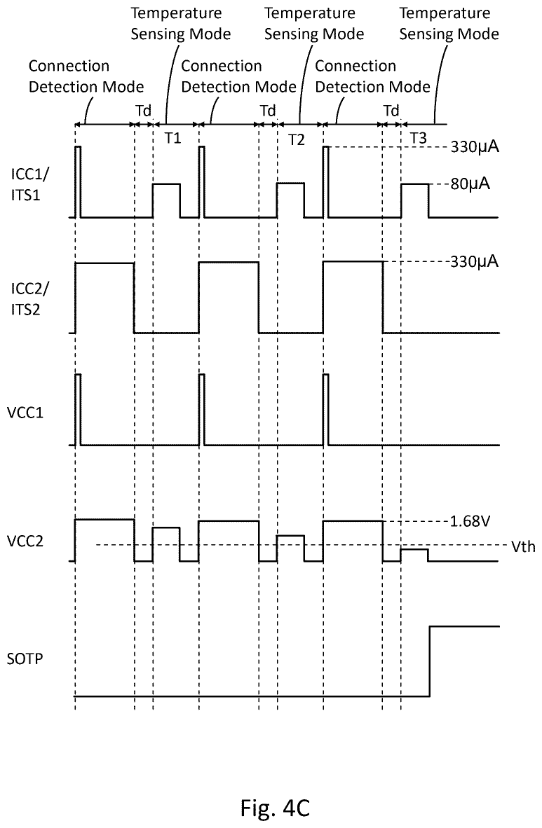

Please refer to both FIG. 3A and FIG. 4A. FIG. 4A illustrates a waveform diagram corresponding to the operation of configuration (1) of the temperature sensing mode according to the present invention. In one embodiment, in the connection detection mode, the first current source circuit 14 is configured to provide the first connection detection current ICC1 (e.g., 330 μA) through the first multifunctional pin CC1_msrc, and the second current source circuit 15 is configured to provide the second connection detection current ICC2 (e.g., 330 μA) through the second multifunctional pin CC2_msrc. The power source circuit is configured to determine whether the power sink circuit is connected to the power source circuit based on the voltage on the first multifunctional pin CC1_msrc and the voltage on the second multifunctional pin CC2_msrc. Specifically, in this embodiment, the configuration channel pin CC2_snk of the power sink circuit is connected to the second multifunctional pin CC2_msrc of the power source circuit. The voltage VCC2 on the second multifunctional pin CC2_msrc is generated based on the second connection detection current ICC2 and the pull-down resistor Rd2. In a specific embodiment, the resistance value of the pull-down resistor Rd2 is 5.1 kΩ, and the voltage VCC2 on the second multifunctional pin CC2_msrc is approximately 1.68V. On the other hand, when the resistance value RN of the temperature sensing component DTS is sufficiently large, a voltage VCC1 on the first multifunctional pin CC1_msrc will be pulled up to the first supply voltage VS1 (e.g., 5V), thereby determining that the configuration channel pin CC1_snk or CC2_snk of the power sink circuit is electrically connected to the second multifunctional pin CC2_msrc.

In one embodiment, when the power sink circuit is detected to be connected to one of the first multifunctional pin CC1_msrc and the second multifunctional pin CC2_msrc, the first connection detection current ICC1 or the second connection detection current ICC2 of the other multifunctional pin is disabled. In this embodiment, as described above, when it is detected that the power sink circuit is connected to the second multifunctional pin CC2_msrc, the first connection detection current ICC1 of the first multifunctional pin CC1_msrc is then disabled. Accordingly, as shown in FIG. 4A, in the connection detection mode, the first connection detection current ICC1 and the voltage VCC1 on the first multifunctional pin CC1_msrc are enabled for a short period and then disabled.

In one embodiment, the resistance value RN of the temperature sensing component DTS is sufficiently large such that, when the power sink circuit is connected to one of the first multifunctional pin CC1_msrc and the second multifunctional pin CC2_msrc, the current source circuit (i.e., the first current source circuit 14 or the second current source circuit 15) of the other multifunctional pin adaptively switches to a low impedance state and becomes coupled to the high voltage. The term “adaptively switches to a low impedance” refers to, for example, a case in which the first current source circuit 14 includes MOS (Metal-Oxide-Semiconductor) transistors. When the resistance value RN of the temperature sensing component DTS is sufficiently large, the first connection detection current ICC1 provided by the first current source circuit 14 causes the voltage VCC1 on the first multifunctional pin CC1_msrc to rise to a level that drives the current source transistor in the first current source circuit 14 into the linear region, thereby exhibiting low impedance. In this embodiment, as shown in FIGS. 3A and 4A, when the power sink circuit is connected to the second multifunctional pin CC2_msrc, the resistance value RN of the temperature sensing component DTS is large enough to cause the first current source circuit 14 which is coupled to the first multifunctional pin CC1_msrc to adaptively switch to a low impedance so as to be coupled to a high voltage (first supply voltage VS1, e.g., 5V). Accordingly, as shown in FIG. 4A, in the connection detection mode, the first connection detection current ICC1 and the voltage VCC1 on the first multifunctional pin CC1_msrc are enabled for a short period and then disabled.

In one embodiment, after the power source circuit and the power sink circuit are connected to each other, digital communication is further performed in a digital communication mode through the first multifunctional pin CC1_msrc or the second multifunctional pin CC2_msrc. It should be noted that the connection detection mode, digital communication mode, and temperature sensing mode are operated in non-overlapping time domains. For example, in one embodiment, as illustrated in FIG. 4A, the digital communication mode is operated during a delay time Td following the connection detection mode.

In one embodiment, as shown in FIG. 3A, in the temperature sensing mode, the analog-to-digital converter ADC1 is configured to measure the voltage VCC1 on the first multifunctional pin CC1_msrc, and the ADC2 is configured to measure the voltage VCC2 on the second multifunctional pin CC2_msrc. In one embodiment, the voltage VN across the temperature sensing component DTS is obtained based on the voltage VCC1 on the first multifunctional pin CC1_msrc and/or the voltage VCC2 on the second multifunctional pin CC2_msrc. Specifically, in one embodiment, the voltage VN across the temperature sensing component DTS is the voltage difference between the voltages VCC1 and VCC2. In one embodiment, as shown in FIG. 4A, under configuration (1), when the voltage VN (VCC1-VCC2) across the temperature sensing component DTS exceeds a predetermined voltage threshold Vth indicating that the temperature information is higher than an over-temperature threshold, an over-temperature protection signal SOTP is enabled to initiate an over-temperature protection (OTP) operation. The term “exceeds” may refer to greater than or less than, depending on the actual embodiment, as will be described later. For example, in the configuration (1) shown in FIG. 4A, “exceeds” means “less than.”

It should be noted that, in this embodiment, since the temperature sensing component DTS is configured as a negative temperature coefficient (NTC) resistor, when the voltage VN across the DTS is less than the predetermined voltage threshold Vth, it indicates that the temperature information is higher than the over-temperature threshold, thereby triggering the OTP operation.

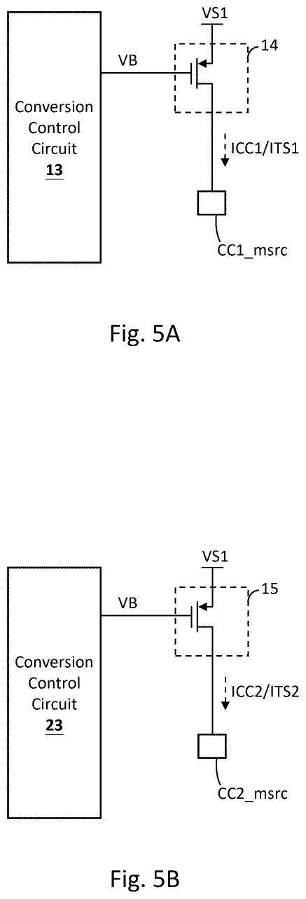

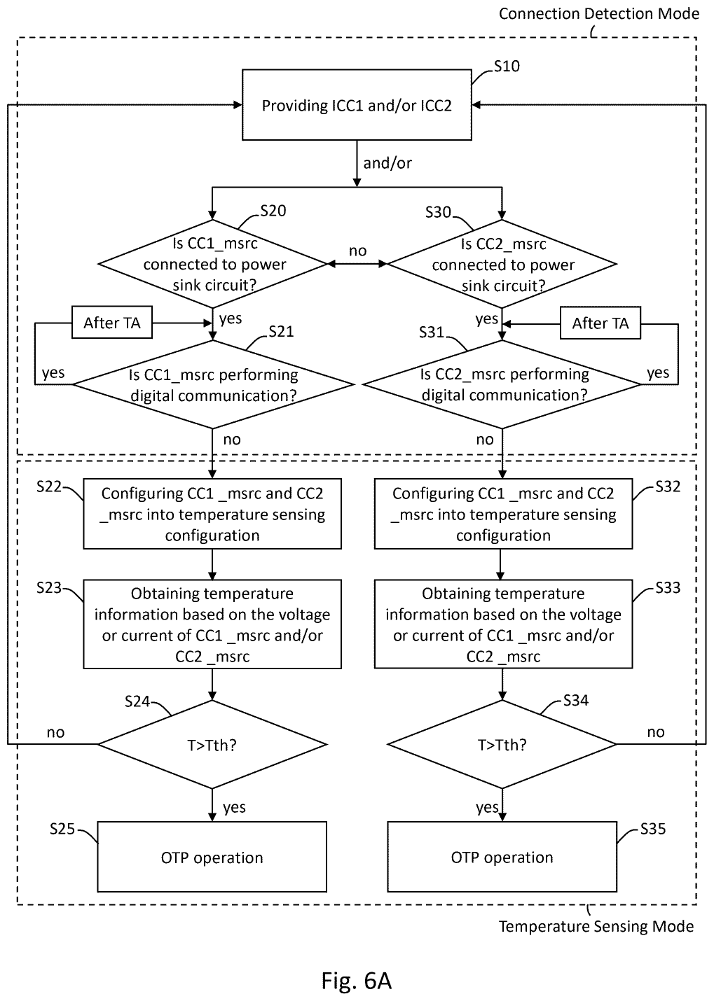

Referring also to FIG. 4A, it should be noted that this embodiment shows an operational waveform in which the temperature increases over time. Referring also to FIGS. 5A and 5B, FIGS. 5A and 5B illustrate partial schematic diagrams of the power source circuit according to embodiments of the present invention. It should also be noted that, in one specific embodiment, as shown in FIGS. 5A and 5B, the first current source circuit 14 and the second current source circuit 15 corresponding to FIG. 3A are configured as PMOS transistors, and are controlled by bias voltages VB generated by the conversion control circuits 13 and 23, respectively. As shown in FIG. 4A, in this embodiment, under configuration (1) in the temperature sensing mode, the voltage level of the voltage VCC1 on the first multifunctional pin CC1_msrc varies with the present temperature. When the temperature is low enough such that the voltage level of the voltage VCC1 becomes sufficiently high (e.g., close to 5V, as in time period T1), the first current source circuit 14 operates in the linear region of the MOS transistor. In this case, the voltage VN across the temperature sensing component DTS is obtained based on the voltage division between the temperature sensing component DTS and the pull-down resistor Rd2, and the temperature information is acquired accordingly. When the temperature rises such that the voltage level of the voltage VCC1 becomes sufficiently low (e.g., dropped below 5V beyond an overdrive margin, as in time periods T2 and T3), the first current source circuit 14 operates in the saturation region of the MOS transistor. In this case, the voltage VN across the temperature sensing component DTS is obtained based on the resistance value RN of the temperature sensing component DTS and the current flowing through it, and the temperature information is accordingly obtained.

In other embodiments, when the resistance value RN of the temperature sensing component DTS is sufficiently small, the voltage VCC1 may remain significantly below 5V even under low-temperature conditions in the temperature sensing mode of configuration (1), as shown in time period T2.

FIG. 4B illustrates an operational waveform diagram corresponding to configuration (2). In FIG. 4B, under the temperature sensing mode with configuration (2), the voltage VCC1 is pulled up to the high voltage (e.g., 5V). Due to the negative temperature effect of the temperature sensing component DTS (which is an NTC resistor), the voltage VCC2 increases as the temperature increases. In one embodiment, it can be directly determined whether an over-temperature condition occurs based on whether the voltage VCC2 exceeds (in this case, is greater than) the predetermined voltage threshold Vth.

FIG. 4C illustrates an operational waveform diagram corresponding to configuration (3). In FIG. 4C, under the temperature sensing mode with configuration (3), the voltage VCC1 is pulled down to ground, and the second current source circuit 15 provides the temperature sensing current ITS2 through the second multifunctional pin CC2_msrc. Due to the negative temperature effect of the temperature sensing component DTS, the voltage VCC2 decreases as the temperature rises. In one embodiment, it can be directly determined whether an over-temperature condition occurs based on whether the voltage VCC2 exceeds (in this case, is less than) the predetermined voltage threshold Vth.

Please refer to FIG. 3B. The power source circuit in FIG. 3B is similar to the power source circuit in FIG. 3A. In one embodiment, as shown in FIG. 3B, a power source communication and control circuit 112 further includes switches SW1 and SW2, and current sensing circuits 16 and 17. In one embodiment, the switch SW1 and the current sensing circuit 16 are connected in series between the first supply voltage VS1 and the first multifunctional pin CC1_msrc, and the switch SW2 and the current sensing circuit 17 are connected in series between the first supply voltage VS1 and the second multifunctional pin CC2_msrc. In one embodiment, the current sensing circuits 16 and 17 can be omitted, and the switches SW1 and SW2 can be directly connected to the first multifunctional pin CC1_msrc and the second multifunctional pin CC2_msrc, respectively.

In one embodiment, in the temperature sensing mode, turning on the switch SW1 or the switch SW2 can configure the temperature sensing configuration into configuration (2). On the other hand, the current sensing circuits 16 and 17 can be configured to sense the current: under configuration (2). Accordingly, the present temperature can be determined based on the calculation of the resistance value RN, the measurement of the voltage VCC2, or the estimation of the current flowing through the temperature sensing component DTS. Other operational details of FIG. 3B can be derived by those skilled in the art based on the descriptions of FIGS. 3A and 4A.

Please refer to FIG. 3C. The power source circuit shown in FIG. 3C is similar to the power source circuit shown in FIG. 3A. In one embodiment, as shown in FIG. 3C, the power source communication and control circuit 113 further includes switches SW1 and SW2, and pull-up resistors Rp1 and Rp2. In one embodiment, the switch SW1 and the pull-up resistor Rp1 are connected in series between a first supply voltage VS1 and the first multifunctional pin CC1_msrc, and the switch SW2 and the pull-up resistor Rp2 are connected in series between the first supply voltage VS1 and the second multifunctional pin CC2_msrc.

In one embodiment, the first connection detection current ICC1 and the second connection detection current ICC2 are provided by the pull-up resistors Rp1 and Rp2, respectively. Specifically, as shown in FIG. 3C, in one embodiment, during the connection detection mode, the switches SW1 and SW2 are turned on. The first connection detection current ICC1 (e.g., 330 μA) is generated based on the first supply voltage VS1 and the pull-up resistor Rp1, and the second connection detection current ICC2 (e.g., 330 μA) is generated based on the first supply voltage VS1 and the pull-up resistor Rp2. Accordingly, the power source communication and control circuit 113 determines whether the power sink circuit is connected to the power source circuit based on the voltage VCC1 on the first multifunctional pin CC1_msrc and the voltage VCC2 on the second multifunctional pin CC2_msrc.

In one embodiment, in the temperature sensing mode, based on the temperature sensing configuration determined by the states of the first multifunctional pin CC1_msrc and the second multifunctional pin CC2_msrc, the first current source circuit 14 and the second current source circuit 15 are respectively configured to provide the temperature sensing current ITS1 and the temperature sensing current ITS2. Other operational details of FIG. 3C can be derived by those skilled in the art based on the descriptions of FIGS. 3A and 4A.

It should be noted that, in the embodiments of FIGS. 3A to 3C, the explanation is given based on an example in which the configuration channel pin CC2_snk of the power sink circuit is connected to the second multifunctional pin CC2_msrc of the power source circuit. However, the scope of the invention is not limited thereto. In other embodiments, the power sink circuit and the power source circuit can have different connection states. For example, the configuration channel pin CC2_snk of the power sink circuit may be connected to the first multifunctional pin CC1_msrc of the power source circuit, or the configuration channel pin CC1_snk of the power sink circuit may be connected to the first multifunctional pin CC1_msrc or the second multifunctional pin CC2_msrc of the power source circuit. The power source circuit can determine whether the power sink circuit is connected to the power source circuit and determine the connection state between the power sink circuit and the power source circuit in the connection detection mode. In the temperature sensing mode, the power source circuit can perform a corresponding temperature sensing operation based on the connection state. Those skilled in the art can derive such implementation details from the previous embodiments.

Furthermore, the aforementioned conversion control circuits (such as 13 and 23) may convert the measured electrical characteristic into temperature information by using logic circuits or a lookup table.

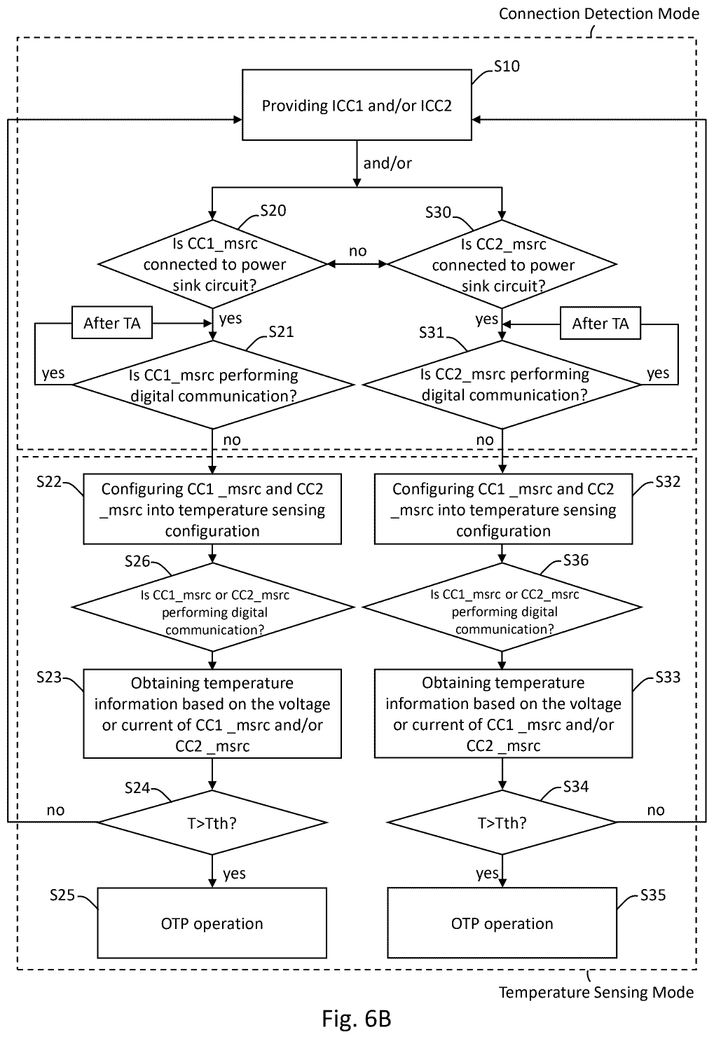

FIGS. 6A and 6B illustrate two operational flowcharts of the power source circuit according to two embodiments of the present invention. In one embodiment, as shown in FIG. 6A, in the connection detection mode, the process starts at step S10, where the first connection detection current ICC1 is provided through the first multifunctional pin CC1_msrc and/or the second connection detection current ICC2 is provided through the second multifunctional pin CC2_msrc. Then, the process proceeds to step S20 and/or step S30, which respectively determine whether the first multifunctional pin CC1_msrc and the second multifunctional pin CC2_msrc are connected to the power sink circuit. The steps following step S20 are similar with the steps following step S30; the following description takes step S30 as an example.

In one embodiment, in the step S30, when it is determined that the second multifunctional pin CC2_msrc is connected to the power sink circuit, the process proceeds to step S31; otherwise, it proceeds to step S20. In one embodiment, the step S31 determines whether digital communication is being performed on the second multifunctional pin CC2_msrc. If the result is yes, the process returns to step S31 after a delay time TA; otherwise, it proceeds to the temperature sensing mode. In one embodiment, the temperature sensing mode begins with step S32, in which the first multifunctional pin CC1_msrc and the second multifunctional pin CC2_msrc are configured into a temperature sensing configuration. The process then proceeds to step S33, where temperature information is obtained based on the measured voltage or current of the first multifunctional pin CC1_msrc and/or the second multifunctional pin CC2_msrc. Specifically, such voltage or current can be used to calculate the voltage VN across the temperature sensing component DTS and/or the current flowing through the temperature sensing component DTS, thereby obtaining the temperature information. The process then proceeds to step S34, which determines whether the temperature information T is higher than an over-temperature threshold Tth. If yes, the process enters step S35 to perform the OTP operation; otherwise, it returns to step S10. The steps S21 to S25 following step S20 can be understood from the above description. For the details of the above steps, please refer to the descriptions of FIGS. 3A to 3C and FIGS. 4A to 4C.

The operation flow in FIG. 6B is similar to that in FIG. 6A. In one embodiment, as shown in FIG. 6B, after step S22 and step S32, the process proceeds to step S26 and step S36, respectively. In this embodiment, in the temperature sensing mode, step S36 determines whether digital communication is being performed on the first multifunctional pin CC1_msrc or the second multifunctional pin CC2_msrc. That is, the power source circuit is further configured to detect whether the first multifunctional pin CC1_msrc or the second multifunctional pin CC2_msrc is performing digital communication with the power sink circuit. When such digital communication is detected, the temperature information generated in the present temperature sensing mode is disregarded, and the process returns to step S30; otherwise, it proceeds to step S33. Step S26 can be derived from the above description.

It should be noted that, when the first multifunctional pin CC1_msrc or the second multifunctional pin CC2_msrc performs digital communication during the temperature sensing mode, it may affect the voltage VN across the temperature sensing component DTS or the current through the temperature sensing component DTS, which may result in inaccurate temperature information. Therefore, in the embodiment of FIG. 6B, steps S26 and S36 further prevent the temperature information from being affected by digital communication. The subsequent temperature sensing step is entered only when it is determined that the first multifunctional pin CC1_msrc or the second multifunctional pin CC2_msrc is not performing digital communication.

It should also be noted that, in one embodiment, a digital communication mode is further included between the connection detection mode and the temperature sensing mode in the process of FIG. 6A or FIG. 6B.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A power source circuit, comprising:
a first multifunctional pin and a second multifunctional pin, configured for communication and temperature sensing, wherein a temperature sensing component is coupled between the first multifunctional pin and the second multifunctional pin;
wherein, in a connection detection mode, a first connection detection current is provided through the first multifunctional pin and/or a second connection detection current is provided through the second multifunctional pin, to detect whether a power sink circuit is connected to the power source circuit, wherein the power sink circuit includes a pull-down resistor coupled to the first multifunctional pin and/or the second multifunctional pin for determining whether the power source circuit is connected to the power sink circuit;
wherein, when the power sink circuit is connected to the power source circuit, in a temperature sensing mode, the first multifunctional pin and the second multifunctional pin are configured into a temperature sensing configuration to generate an electrical characteristic on the temperature sensing component, and to obtain the electrical characteristic through the first multifunctional pin and/or the second multifunctional pin, thereby performing temperature sensing and obtaining a temperature information.

2. The power source circuit of claim 1, wherein the temperature sensing configuration includes: providing a first predetermined voltage or a first predetermined current through the first multifunctional pin, or configuring the first multifunctional pin as floating; and providing a second predetermined voltage or a second predetermined current through the second multifunctional pin, or configuring the second multifunctional pin as floating;
wherein the electrical characteristic includes at least one of the following: a voltage on the first multifunctional pin, a current through the first multifunctional pin, a voltage on the second multifunctional pin, a current through the second multifunctional pin, and/or a resistance value of the temperature sensing component.

3. The power source circuit of claim 2, wherein, when the power sink circuit is connected to the power source circuit, one multifunctional pin of the first multifunctional pin and the second multifunctional pin is connected to the power sink circuit, and the other multifunctional pin of the first multifunctional pin and the second multifunctional pin is not connected to the power sink circuit;
wherein the temperature sensing configuration includes one of the following:
(1) providing a temperature sensing current through the other multifunctional pin and configuring the one multifunctional pin as floating;
(2) providing a predetermined high voltage through the other multifunctional pin and configuring the one multifunctional pin as floating; or
(3) providing a temperature sensing current through the one multifunctional pin and providing a predetermined low voltage through the other multifunctional pin.

4. The power source circuit of claim 2, wherein the power source circuit complies with a universal serial bus (USB) Type-C specification, and the first multifunctional pin and the second multifunctional pin respectively correspond to a first configuration channel (CC) pin and a second configuration channel (CC) pin of the USB Type-C.

5. The power source circuit of claim 4, wherein, after the power sink circuit is connected to the power source circuit, in a digital communication mode, the power source circuit further performs digital communication with the power sink circuit through the first CC pin or the second CC pin, wherein the digital communication mode and the temperature sensing mode are operated in non-overlapping time domains.

6. The power source circuit of claim 2, wherein the first multifunctional pin and the second multifunctional pin are further configured to perform digital communication with the power sink circuit in a digital communication mode, wherein the digital communication mode and the temperature sensing mode are operated in non-overlapping time domains.

7. The power source circuit of claim 6, wherein, in the temperature sensing mode, the power source circuit is further configured to detect whether the first multifunctional pin or the second multifunctional pin is performing digital communication with the power sink circuit, and when such digital communication is detected, the temperature information generated in the temperature sensing mode is disregarded, and temperature sensing is performed again when the temperature sensing mode is subsequently entered.

8. The power source circuit of claim 1, wherein the first connection detection current and the second connection detection current are provided by a pull-up resistor or a current source circuit.

9. The power source circuit of claim 1, wherein, in the temperature sensing mode, when the electrical characteristic exceeds a predetermined threshold indicating that the temperature information is higher than an over-temperature threshold, an over-temperature protection (OTP) operation is performed.

10. The power source circuit of claim 3, wherein the temperature sensing current is lower than both the first connection detection current and the second connection detection current.

11. The power source circuit of claim 2, wherein, in the temperature sensing mode, a voltage across the temperature sensing component is obtained by measuring the voltage on the first multifunctional pin and/or measuring the voltage on the second multifunctional pin, or a current through the temperature sensing component is obtained by measuring the current through the first multifunctional pin and/or the second multifunctional pin.

12. The power source circuit of claim 2, wherein, in the connection detection mode, whether the power sink circuit is connected to the power source circuit is determined based on the voltage on the first multifunctional pin and the voltage on the second multifunctional pin, and when the power sink circuit is detected to be connected to one of the first multifunctional pin and the second multifunctional pin, the first connection detection current or the second connection detection current of the other multifunctional pin is disabled.

13. The power source circuit of claim 2, wherein the temperature sensing component is configured as a negative temperature coefficient (NTC) resistor.

14. The power source circuit of claim 3, wherein the temperature information is obtained in one of the following ways:
when the temperature sensing configuration is configured as (1) or (2), the temperature information is determined based on a voltage across the temperature sensing component and a current through the other multifunctional pin;
when the temperature sensing configuration is configured as (1) or (2), the temperature information is determined based on a voltage division ratio between the temperature sensing component and the pull-down resistor;
when the temperature sensing configuration is configured as (2), the temperature information is determined based on a voltage on the one multifunctional pin; or
when the temperature sensing configuration is configured as (3), the temperature information is determined based on a voltage on the one multifunctional pin.

15. The power source circuit of claim 14, wherein the temperature information is further determined based on a resistance value of the pull-down resistor.

16. The power source circuit of claim 2, wherein the first connection detection current and the second connection detection current are provided by a first current source circuit and a second current source circuit, respectively, and the resistance value of the temperature sensing component is large enough such that, in the connection detection mode, when the power sink circuit is connected to one of the first multifunctional pin and the second multifunctional pin, the first current source circuit or the second current source circuit of the other multifunctional pin adaptively switches to a low impedance so as to be coupled to a high voltage.

17. A control method for controlling a power source circuit, comprising:
providing a first multifunctional pin and a second multifunctional pin, configured for communication and temperature sensing, wherein a temperature sensing component is coupled between the first multifunctional pin and the second multifunctional pin;
in a connection detection mode, providing a first connection detection current through the first multifunctional pin and/or providing a second connection detection current through the second multifunctional pin to detect whether a power sink circuit is connected to the power source circuit, wherein the power sink circuit includes a pull-down resistor coupled to the first multifunctional pin and/or the second multifunctional pin for determining whether the power source circuit is connected to the power sink circuit;
when the power sink circuit is connected to the power source circuit, in a temperature sensing mode, configuring the first multifunctional pin and the second multifunctional pin into a temperature sensing configuration to generate an electrical characteristic on the temperature sensing component; and
obtaining the electrical characteristic through the first multifunctional pin and/or the second multifunctional pin to perform temperature sensing and obtain temperature information.

18. The control method of claim 17, wherein the configuring of the temperature sensing configuration includes: providing a first predetermined voltage or a first predetermined current through the first multifunctional pin, or configuring the first multifunctional pin as floating; and providing a second predetermined voltage or a second predetermined current through the second multifunctional pin, or configuring the second multifunctional pin as floating;
wherein the electrical characteristic includes at least one of the following: a voltage on the first multifunctional pin, a current through the first multifunctional pin, a voltage on the second multifunctional pin, a current through the second multifunctional pin, and/or a resistance value of the temperature sensing component.

19. The control method of claim 18, wherein, when the power sink circuit is connected to the power source circuit, one multifunctional pin of the first multifunctional pin and the second multifunctional pin is connected to the power sink circuit, and the other multifunctional pin of the first multifunctional pin and the second multifunctional pin is not connected to the power sink circuit;
wherein the configuring of the temperature sensing configuration includes one of the following:
(1) providing a temperature sensing current through the other multifunctional pin and configuring the one multifunctional pin as floating;
(2) providing a predetermined high voltage through the other multifunctional pin and configuring the one multifunctional pin as floating; or
(3) providing a temperature sensing current through the one multifunctional pin and providing a predetermined low voltage through the other multifunctional pin.

20. The control method of claim 18, further comprising:
in a digital communication mode, performing digital communication with the power sink circuit through the first multifunctional pin and the second multifunctional pin;
wherein the digital communication mode and the temperature sensing mode are operated in non-overlapping time domains.

21. The control method of claim 20, further comprising:
in the temperature sensing mode, detecting whether the first multifunctional pin or the second multifunctional pin performs digital communication with the power sink circuit;
when such digital communication is detected, disregarding the temperature information generated in the temperature sensing mode; and
performing temperature sensing again when the temperature sensing mode is subsequently entered.

22. The control method of claim 17, further comprising: in the temperature sensing mode, when the electrical characteristic exceeds a predetermined threshold indicating that the temperature information is higher than an over-temperature threshold, performing an over-temperature protection (OTP) operation.

23. The control method of claim 19, wherein the temperature sensing current is lower than both the first connection detection current and the second connection detection current.

24. The control method of claim 18, wherein in the temperature sensing mode, the step of obtaining the electrical characteristic includes:
measuring the voltage on the first multifunctional pin and/or the voltage on the second multifunctional pin to obtain a voltage across the temperature sensing component; or
measuring the current through the first multifunctional pin and/or the second multifunctional pin to obtain a current through the temperature sensing component.

25. The control method of claim 18, further comprising:
in the connection detection mode, determining whether the power sink circuit is connected to the power source circuit based on the voltage on the first multifunctional pin and the voltage on the second multifunctional pin; and
when the power sink circuit is detected to be connected to one of the first multifunctional pin and the second multifunctional pin, disabling the first connection detection current or the second connection detection current of the other multifunctional pin.

26. The control method of claim 19, wherein the step of obtaining the temperature information includes one of the following:
when the temperature sensing configuration is configured as (1) or (2), determining the temperature information based on a voltage across the temperature sensing component and a current through the other multifunctional pin;
when the temperature sensing configuration is configured as (1) or (2), determining the temperature information based on a voltage division ratio between the temperature sensing component and the pull-down resistor;
when the temperature sensing configuration is configured as (2), determining the temperature information based on a voltage on the one multifunctional pin; or
when the temperature sensing configuration is configured as (3), determining the temperature information based on a voltage on the one multifunctional pin.

27. The control method of claim 26, further comprising: determining the temperature information based on a resistance value of the pull-down resistor.

28. The control method of claim 18, wherein the first connection detection current and the second connection detection current are provided by a first current source circuit and a second current source circuit, respectively, and the resistance value of the temperature sensing component is large enough such that, when the power sink circuit is connected to one of the first multifunctional pin and the second multifunctional pin, the first current source circuit or the second current source circuit of the other multifunctional pin adaptively switches to a low impedance so as to be coupled to a high voltage.
